(19) United States
(12) Patent Application Publication
(10) Pub. No.: US 2013/0024666 A1
(43) Pub. Date: Jan. 24, 2013

(54) METHOD OF SCHEDULING A PLURALITY OF INSTRUCTIONS FOR A PROCESSOR

(71) Applicants: JENQ KUEN LEE, HSINCHU (TW); YU TE LIN, HSINCHU (TW); CHUNG JU WU, HSINCHU (TW)

(72) Inventors: JENQ KUEN LEE, HSINCHU (TW); YU TE LIN, HSINCHU (TW); CHUNG JU WU, HSINCHU (TW)

(73) Assignee: NATIONAL TSING HUA UNIVERSITY, HSINCHU (TW)

(21) Appl. No.: 13/184,857

(22) Filed: Jul. 18, 2011

(51) Int. Cl. G06F 9/312

(52) U.S. Cl. 712/214; 712/E09.033

(57) ABSTRACT

A method of scheduling a plurality of instructions for a processor comprises the steps of: establishing a functional unit resource table comprising a plurality of columns, each of which corresponds to one of a plurality of operation cycles of the processor and comprises a plurality of fields, each of which indicates a functional unit of the processor; establishing a ping-pong resource table comprising a plurality of columns, each of which corresponds to one of the plurality of operation cycles of the processor and comprises a plurality of fields, each of which indicates a read port or a write port of a register bank of the processor; and allotting the plurality of instructions to the plurality of operation cycles of the processor and registering the functional units and the ports of the register banks corresponding to the allotted instructions on the functional unit resource table and the ping-pong resource table.

### BACKGROUND OF THE INVENTION

1. Field of the Invention

The present invention relates to a method of scheduling a plurality of instructions for a processor, and more particularly, to a method of scheduling a plurality of instructions for a processor with distributed register files.

2. Description of the Related Art

Instruction-level parallelism (ILP) is increasingly deployed in high-performance digital signal processors (DSPs) with very long instruction word (VLIW) data-path architectures. Such DSPs usually have multiple functional units, and the number of read/write ports connecting register files increases with the number of functional units. The distributed register-file design is adopted to reduce the amount of read/write ports in registers. The distributed register-file design includes features such as multi-cluster register files, multiple banks, and limited temporal connectivities such as ping-pong architectures. These architectures have been shown to be able to reduce the number of read/write ports in registers and reduce power consumption while sustaining high ILP in VLIW architectures.

FIG. 1 illustrates the architecture of a PAC processor utilizing distributed register files and a ping-pong architecture. The PAC processor 10 comprises a first cluster 12A and a second cluster 12B, wherein each cluster 12A and 12B comprises a first functional unit 20, a second functional unit 30, a first local register file 14 connected to the first functional unit 20, a second local register file 16 connected to the second functional unit 30, and a global register file 22 having a ping-pong structure formed by a first register bank B1 and a second register bank B2. Each register file includes a plurality of registers. The PAC processor 10 comprises a third functional unit 40, which is placed independent of and outside the first cluster 12A and the second cluster 12B. A third local register file 18 is connected to the third functional unit 40. The first functional unit 20 is a load/store unit (M-Unit), the second functional unit 30 is an arithmetic unit (I-Unit), and the third functional unit 40 is a scalar unit (B-unit). The third functional unit 40 controls branch operations and is also capable of performing simple load/store and address arithmetic. The first local register file 14, the second local register file 16, and the third local register file 18 are only accessible by the M-Unit 20, I-Unit 30, and B-Unit 40, respectively. Each register bank of global register file 22 has only a single set of access ports, shared by the M-Unit 20 and I-Unit 30. Each access port of register bank B1 or B2 of the global register file 22 can only be accessed by either the first functional unit 20 or the second functional unit 30 in an operation cycle, so these two functional units 20, 30 can only access different access ports of banks B1 or B2 in each operation cycle. This is an access constraint of the ping-pong structure.

The presence of distributed register-file architectures featuring multiple clusters, multi-bank register files, and limited temporal connectivities in embedded VLIW DSPs presents challenges for compilers attempting to generate efficient codes for multimedia applications. Research on compiler optimizations to address this issue first addressed issues related to cluster-based architectures. This includes partitioning register files to work with instruction scheduling, and loop partitions for clustered register files. However, if a conventional instruction scheduling method is used without taking the ping-pong structure exhibited into account, a preferable instruction scheduling result is difficult to achieve.

### SUMMARY OF THE INVENTION

The PAC processor according to one embodiment of the present invention comprises a first cluster and a second cluster. Each cluster comprises a first functional unit, a second functional unit, a first local register file connected to the first functional unit, a second local register file connected to the second functional unit, and a global register file having a ping-pong structure formed by a first register bank and a second register bank. The register bank of global register file comprises a single set of access ports shared by the first and second functional units.

The method of scheduling a plurality of instructions for a processor according to one embodiment of the present invention comprises the steps of: establishing a functional unit resource table comprising a plurality of columns, each of which corresponds to one of a plurality of operation cycles of the processor and comprises a plurality of fields, each of which indicates a functional unit of the processor; establishing a ping-pong resource table comprising a plurality of columns, each of which corresponds to one of the plurality of operation cycles of the processor and comprises a plurality of fields, each of which indicates a read port or a write port of a register bank of the processor; and allotting the plurality of instructions to the plurality of operation cycles of the processor and registering the functional units and the ports of the register banks corresponding to the allotted instructions on the functional unit resource table and the ping-pong resource table.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 illustrates the architecture of a PAC processor utilizing the ping-pong architecture;

FIG. 2 shows a flow chart of the method of providing a schedule for a PAC processor according to an embodiment of the present invention.

FIG. 3 shows the procedure of scheduling a plurality of instructions for a processor according to a conventional method;

FIG. 4 shows a flow chart of the method of scheduling a plurality of instructions for a PAC processor according to an embodiment of the present invention; and

FIG. 5 shows the procedure of scheduling a plurality of instructions for a processor according to an embodiment of the present invention.

### DETAILED DESCRIPTION OF THE INVENTION

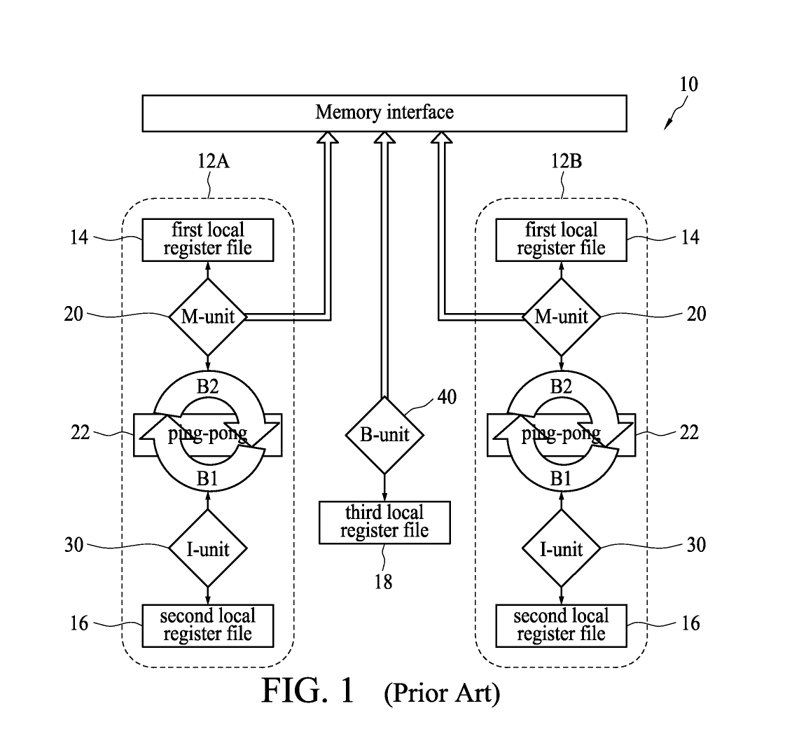

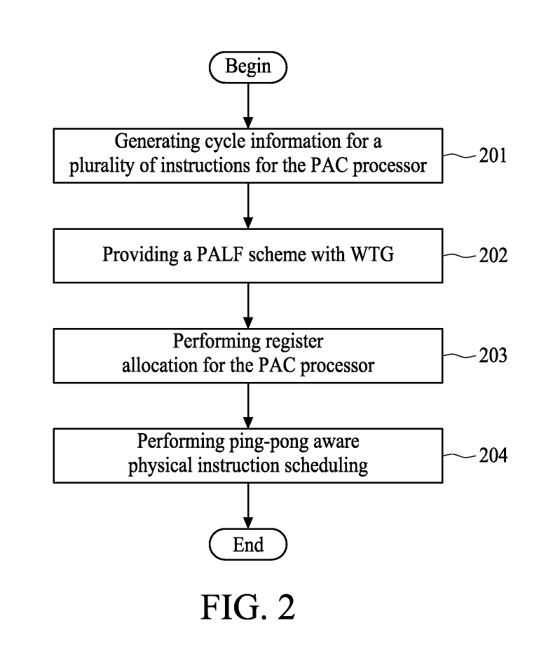

FIG. 2 shows a flow chart of the method of providing a schedule for a PAC processor according to an embodiment of the present invention. The method shown in FIG. 2 is applicable to the PAC processor 10 shown in FIG. 1, wherein in this embodiment, the first register bank B1 comprises registers of d0 to d7, and the second register bank B2 comprises registers of d8 to d15. In step 201, cycle information for a plurality of instructions for the PAC processor 10 is generated by using a pseudo scheduler, and step 202 is executed. In step 202, a pioneering ping-pong-aware local-favorable (PALF) scheme with timing graph (WTG) is provided, and step 203 is executed. In step 203, register allocation for the PAC processor 10 is performed based on the cycle information, and step 204 is executed. In step 204, a ping-pong aware physical instruction scheduling is performed.

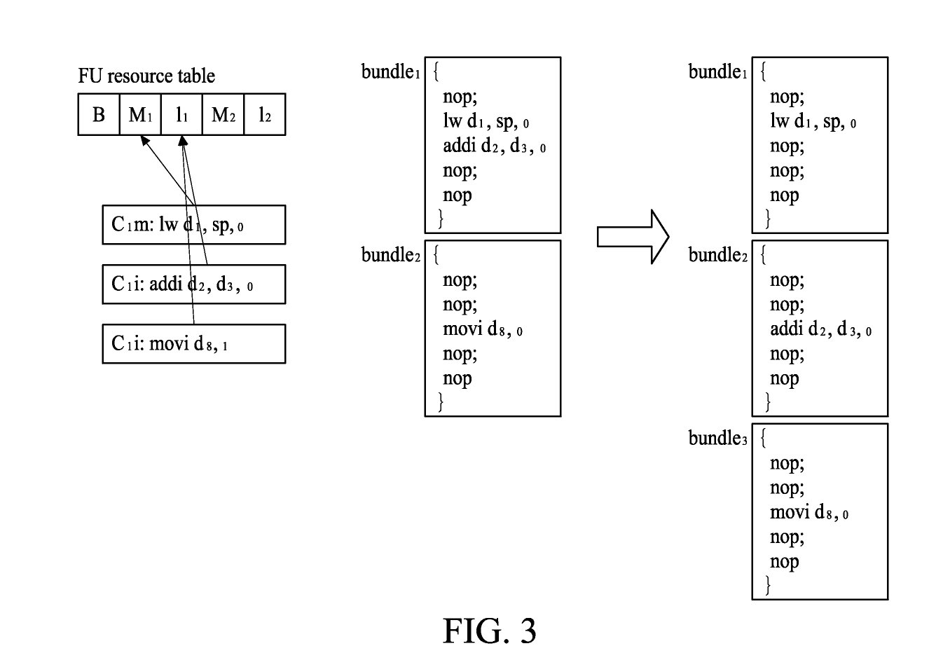

Accordingly, through steps 201 to 203 shown in FIG. 2, the register allocation for the PAC processor 10 is achieved, and the remaining step for providing a schedule for the PAC processor 10 is to perform a physical instruction scheduling for the PAC processor 10. FIG. 3 shows the procedure of scheduling a plurality of instructions for a processor according to a conventional method. As shown in FIG. 3, the conventional method utilizes a general scheduler, which comprises a functional unit resource table. The functional unit resource table comprises a plurality of columns corresponding to the operation cycles of the PAC processor 10. Each column comprises a plurality of fields, and each field indicates a functional unit of the PAC processor 10, i.e., M1 represents the M-unit 20 of the cluster 12A, I1 represents the I-unit 30 of the cluster 12A, M2 represents the M-unit 20 of the cluster 12B, 12 represents the I-unit 30 of the cluster 12B, and B1 represents the B-unit 40. FIG. 3 also shows three instructions for the PAC processor 10. Since the PAC processor 10 uses VLIW architecture, more than one instruction can be executed in one operation cycle. In this embodiment, the instructions being executed in one operation cycle are wrapped in a bundle, wherein as shown in FIG. 3, at most five instructions, as corresponding to the number of functional units of the PAC processor 10, can be executed in one operation cycle.

The first instruction [C₁ₘ: 1w d1, sp, 0] uses the M-unit 20 of the cluster 12A, and thus the field M1 of the present operation cycle of the functional unit resource table is checked. The second instruction [C₁ᵢ: addi d2, d3, 0] uses the I-unit 30 of the cluster 12A, and thus the field I1 of the present operation cycle of the functional unit resource table is checked. The third instruction [C₁ᵢ: movi d8, 1] uses the I-unit 30 of the cluster 12A. However, since the field I1 of the present operation cycle of the functional unit resource table is already checked, the third instruction [C₁ᵢ: movi d8] is scheduled to the next operation cycle. As shown in FIG. 3, the first instruction [C₁ₘ: 1w d1, sp, 0] and the second instruction [C₁ᵢ: addi d2, d3, 0] are scheduled in bundle 1, and the third instruction [C₁ᵢ: movi d8] is scheduled in bundle 2.

However, since the PAC processor 10 utilizes a global register file having a ping-pong structure formed by the first register bank B1 and the second register bank B2, the schedule of the instructions has to meet the constraint of the ping-pong structure. That is, a read/write port of a register bank cannot be accessed by more than one functional unit during a single operation cycle. In other words, if the read port of one bank is accessed by a functional unit during an operation cycle, that read port cannot be accessed by another functional unit during the same operation cycle. Accordingly, if the first instruction [C₁ₘ: 1w d1, sp, 0] and the second instruction [C₁ᵢ: addi d2, d3, 0] are both scheduled to access the first register bank B1 during the same operation cycle as the registers d1 and d2 both belong to the first register bank B1, the ping-pong constraint would be violated. Therefore, another operation cycle is required to carry out the instructions scheduled in bundle 1. As a result, as shown in FIG. 3, after a further scheduling, the first instruction [C₁ₘ: 1w d1, sp, 0] is scheduled in bundle 1, the second instruction [C₁ᵢ: addi d2, d3, 0] is scheduled in bundle 2, and the third instruction [C₁ᵢ: movi d8] is scheduled in bundle 3. However, the scheduling result is not a preferable result since the scheduling procedure does not take the ping-pong structure exhibited by the PAC processor 10 into account in advance.

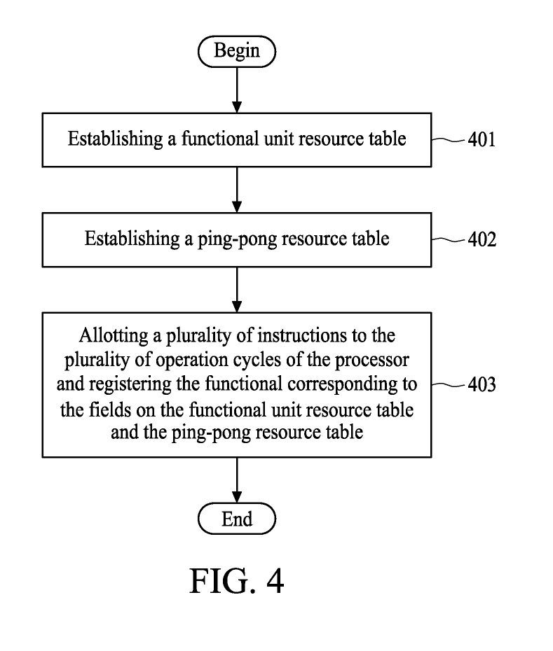

FIG. 4 shows a flow chart of the method of scheduling a plurality of instructions for a processor according to an embodiment of the present invention. The method shown in FIG. 4 is applicable to the PAC processor 10 shown in FIG. 1. In step 401, a functional unit resource table is established, and step 402 is executed, wherein the functional unit resource table comprises a plurality of columns, each of the columns corresponds to one of a plurality of operation cycles of the processor and comprises a plurality of fields, and each of the fields indicates a functional unit of the processor. In step 402, a ping-pong resource table is established, and step 403 is executed, wherein the ping-pong resource table comprises a plurality of columns, each of the columns corresponds to one of the plurality of operation cycles of the processor and comprises a plurality of fields, and each of the fields indicates a read port or a write port of a register bank of the processor. In step 403, a plurality of instructions are allotted to a plurality of operation cycles of the processor, and the functional units and the ports of the register banks corresponding to the allotted instructions on the functional unit resource table and the ping-pong resource table are registered.

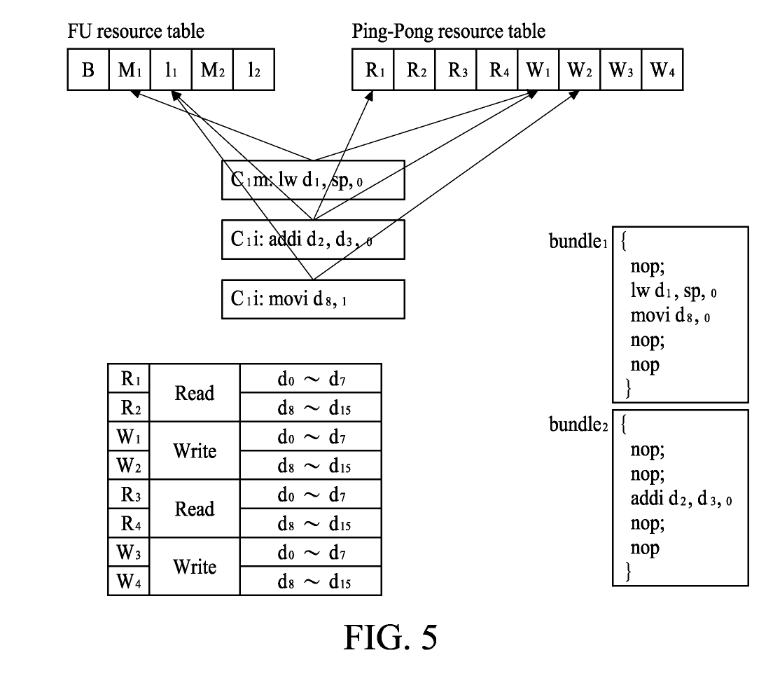

FIG. 5 shows the procedure of scheduling a plurality of instructions for a processor according to an embodiment of the present invention. Similar to the procedure shown in FIG. 3, there are three instructions to be scheduled. Unlike the procedure shown in FIG. 3, however, in addition to the functional unit resource table, a ping-pong resource table is also established. Each field of a column of the ping-pong resource table indicates a read port or a write port of a register bank of the PAC processor 10. That is, each column comprises eight fields R1, R2, R3, R4, W1, W2, W3 and W4, wherein R1 indicates the read port of the first register bank B1 of the cluster 12A, R2 indicates the read port of the second register bank B2 of the cluster 12A, R3 indicates the read port of the first register bank B1 of the cluster 12B, R4 indicates the read port of the second register bank B2 of the cluster 12B, W1 indicates the write port of the first register bank B1 of the cluster 12A, W2 indicates the write port of the second register bank B2 of the cluster 12A, W3 indicates the write port of the first register bank B1 of the cluster 12B, and W4 indicates the write port of the second register bank B2 of the cluster 12B.

In this embodiment, step 403 is resolved in a cycle-by-cycle manner. That is, the instructions scheduled to the present operation cycle are allotted before the scheduling for the next operation cycle. In addition, in this embodiment, a thorough search is performed for each operation cycle. That is, all of the lists of the instructions to be scheduled are inspected to determine if they are to be scheduled in the present operation cycle before the scheduling for the next operation cycle.

Referring to FIG. 5, the first instruction [C₁ₘ: 1w d1, sp, 0] uses the M-unit 20 of the cluster 12A and accesses the write port of the first register bank B1 of the cluster 12A. Accordingly, the first instruction [C₁ₘ: 1w d1, sp, 0] is allotted to bundle 1, and the field M1 of the present operation cycle of the functional unit resource table, the field W1 of the present operation cycle of the ping-pong resource table are both registered. The second instruction [C₁ᵢ: addi d2, d3, 0] uses the I-unit 30 of the cluster 12A and accesses the write port of the first register bank B1 of the cluster 12A. Since the field W1 of the present operation cycle of the ping-pong resource table is already registered, the second instruction [C₁ᵢ: addi d2, d3, 0] is ignored until the next operation cycle. The third instruction [C₁ᵢ: movi d8, 1] uses the I-unit 30 of the cluster 12A and the write port of the second register bank B2 of the cluster 12A. Accordingly, the third instruction [C₁ᵢ: movi d8, 1] is allotted to bundle 1, and the field I1 of the present operation cycle of the functional unit resource table, the field W2 of the present operation cycle of the ping-pong resource table are both registered. For the next operation cycle, the second instruction [C₁ᵢ: addi d2, d3, 0] is allotted to bundle 2.

Comparing the scheduling result shown in FIG. 5 and the scheduling result shown in FIG. 3, it can be seen that the scheduling result provided by the method shown in FIG. 4 uses fewer operation cycles than the conventional method. In conclusion, the method of scheduling a plurality of instructions for a processor provided by the present invention utilizes a functional unit resource table and a ping-pong resource table such that the access constraint of the ping-pong structure is taken into account in the scheduling procedure.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of scheduling a plurality of instructions for a processor, the processor comprising a first cluster and a second cluster, each cluster comprising a first functional unit, a second functional unit, a first local register file connected to the first functional unit, a second local register file connected to the second functional unit, and a global register file having a ping-pong structure formed by a first register bank and a second register bank, the global register file connected to the first and second functional units, the method comprising the steps of:
establishing a functional unit resource table comprising a plurality of columns, each of which corresponds to one of a plurality of operation cycles of the processor and comprises a plurality of fields, each of which indicates a functional unit of the processor;
establishing a ping-pong resource table comprising a plurality of columns, each of which corresponds to one of the plurality of operation cycles of the processor and comprises a plurality of fields, each of which indicates a read port or a write port of a register bank of the processor; and
allotting the plurality of instructions to the plurality of operation cycles of the processor and registering the functional units and the ports of the register banks corresponding to the allotted instructions on the functional unit resource table and the ping-pong resource table.

2. The method of claim 1, wherein the allotting step further comprises the sub-steps of:
allotting one or more of the plurality of instructions to a present operation cycle if all of the fields indicating the functional units and the ports of the register banks corresponding to the allotted instruction of the column of the present operation cycle of the functional unit resource table and the ping-pong resource table are unregistered;
registering the functional units and the ports of the register banks corresponding to the allotted instruction on the functional unit resource table and the ping-pong resource table; and
setting a next operation cycle as the present operation cycle and repeating the allotting step and the registering step.

3. The method of claim 1, wherein the allotting step further comprises the sub-steps of:
inspecting one of the plurality of instructions;
allotting the inspected instruction to a present operation cycle if all of the fields indicating the functional units and the ports of the register banks corresponding to the inspected instruction of the column of the present operation cycle of the functional unit resource table and the ping-pong resource table are unregistered;
ignoring the inspected instruction if one of the fields indicating the functional units and the ports of the register banks corresponding to the inspected instruction of the column of the present operation cycle of the functional unit resource table and the ping-pong resource table is registered;
registering the functional units and the ports of the register banks corresponding to the allotted instruction on the functional unit resource table and the ping-pong resource table; and
repeating the inspecting step until all of the instructions are inspected, and setting a next operation cycle as the present operation cycle.

4. The method of claim 1, wherein the first register bank has eight registers.

5. The method of claim 1, wherein the second register bank has eight registers.

6. The method of claim 1, wherein the first functional unit is a load/store unit.

7. The method of claim 1, wherein the second functional unit is an arithmetic unit.

8. The method of claim 1, wherein the processor further comprises a third functional unit connected between the first cluster and the second cluster and a third local register file connected to the third functional unit.
